(19) United States
(12) Patent Application Publication
(10) Pub. No.: US 2025/0065807 A1
(43) Pub. Date: Feb. 27, 2025

(54) Display System for a Vehicle for Realizing an Augmented Vehicle Mirror Function

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Alan KEIM, Hallbergmoos (DE); Manfred PAULI, Bruckberg (DE)

(21) Appl. No.: 18/808,245

(22) Filed: Aug. 19, 2024

(30) Foreign Application Priority Data
Aug. 25, 2023 (DE) 10 2023 122 914.1

(51) Int. Cl. B60R 1/26; G06T 19/00; H04N 7/18; H04N 13/243; H04N 13/344

(52) U.S. Cl. CPC B60R 1/26; G06T 19/006; H04N 7/181; H04N 13/243; H04N 13/344; B60R 2300/20; B60R 2300/303

(57) ABSTRACT

A method for operating a display system for smartglasses in a motor vehicle includes ascertaining a spatial image representation of a rear vehicle environment with the aid of an environment capture device includes a camera system for providing a camera image representation and a 3D capture device for providing a distance profile; communicating at least one portion of the spatial image representation of the rear vehicle environment as object information to the smartglasses; and performing contact-analog presentation of display images on a display surface of the smartglasses in a presentation region at a vehicle-fixed position, which region corresponds to a vehicle mirror position, wherein the display images are created stereoscopically depending on the spatial image representation of the rear vehicle environment with the aid of a graphics engine implemented in the smartglasses in order to enable a spatial presentation of environment objects of the rear vehicle environment.

### CROSS REFERENCE TO RELATED APPLICATION

This application claims priority under 35 U.S.C. § 119 from German Patent Application No. DE 10 2023 122 914.1, filed Aug. 25, 2023, the entire disclosure of which is herein expressly incorporated by reference.

### BACKGROUND AND SUMMARY

The invention relates to display systems comprising augmented reality smartglasses for use in a vehicle. The invention furthermore relates to the realization of a virtual vehicle mirror with improved hazard recognition.

Augmented reality smartglasses, also called head-mounted displays, which are able to present an image representation on one or two display surfaces in the field of view of the wearer of the smartglasses with the aid of a display apparatus, are known. The display surfaces may correspond to reflection surfaces that direct image representations into the eye of the wearer of the smartglasses. The viewing openings in the smartglasses are transparent, such that it is also possible to perceive the real environment in the usual way through the display surfaces of the smartglasses. The display surfaces are arranged in the viewing openings such that information to be displayed, such as text, symbols, graphics, video displays and the like, can be displayed in a manner superimposed on the perception of the environment.

The information can be presented in a contact-analog or positionally faithful manner to the wearer of the smartglasses, i.e. presented in such a way that the information, as display objects, is superimposed on or oriented to a specific assigned environment object or a specific position or a specific local area in the real environment, or that the display object to be displayed is displayed in a specific alignment/orientation of the smartglasses or the wearer thereof.

Furthermore, display systems are known which display a back or rear vehicle region on a screen display, in particular in order to facilitate reversing.

The document DE 10 2017 221 317 A1 relates e.g. to a method for operating a display system comprising smartglasses in a motor vehicle, comprising the following steps:
providing an indication about positions of one or more environment objects in the environment of the motor vehicle in a vehicle-fixed coordinate system;
ascertaining a pose of the smartglasses in the vehicle-fixed coordinate system;
providing a position and size of a vehicle mirror;
providing in each case object information which is assigned to the one or more environment objects and which indicates in each case an indication about a virtual object to be displayed and the position thereof in the vehicle-fixed coordinate system;
determining a mirror region on one or more display surfaces of the smartglasses depending on a pose of the smartglasses and the position and size of the vehicle mirror; and
modifying a display of the virtual object in the mirror region.

The assistance of a driver of a motor vehicle by way of virtual vehicle mirrors is helpful since the rear view can be presented to the driver in a forward view and so the need for the driver to turn their head can thus be obviated in many cases, which means greater convenience for the driver. Virtual vehicle mirrors correspond to an electronic system in which a rear vehicle environment can be captured with the aid of one or more cameras and can be output to the driver in real time by way of a suitable display in the instrument panel or in the region of a vehicle mirror.

However, when viewing environment objects in the real vehicle mirror and in the virtual vehicle mirror, it is considerably more difficult to assess the spatial depth and in particular the distance to an environment object. As a result, hazard situations may possibly not be perceived, or not perceived in a timely manner.

It is therefore an object of the present invention, with the assistance of augmented reality smartglasses in a display system, to enable an improved view of a region of the rear vehicle environment of a vehicle, which view enables an improved perception of the depth and the distance to surrounding objects.

This object is achieved by the method for operating a display system for augmented reality smartglasses and a display system according to the claimed invention.

According to a first aspect, a method for operating a display system for smartglasses in a motor vehicle is provided, comprising the following steps:
ascertaining a spatial image representation of a rear vehicle environment with the aid of an environment capture device, comprising in particular a camera system and/or a 3D capture device;
communicating at least one portion of the spatial image representation of the rear vehicle environment as object information to the smartglasses; and
contact-analog presentation of display images on display surfaces of the smartglasses in a presentation region at a vehicle-fixed position, which region corresponds to a vehicle mirror position, wherein the display images are created stereoscopically depending on the spatial image representation of the rear vehicle environment with the aid of a graphics engine implemented in the smartglasses in order to enable a spatial presentation of environment objects of the rear vehicle environment.

A general problem for real vehicle mirrors and for virtual vehicle mirrors in a vehicle is that the perceived image representation of the rear vehicle environment allows no or only inadequate spatial perception of environment objects.

A display system is described herein which has an assistance system in the vehicle and smartglasses that are connected or connectable to the assistance system. The assistance system is designed to capture and to create a spatial image representation of a rear vehicle environment on the basis of one or more cameras of a camera system arranged on an exterior of the vehicle and on the basis of a 3D capture device for capturing distances to environment objects. At least one portion of the spatial image representation of the rear vehicle environment is communicated to the smartglasses in real time, such that this is presentable in a positionally faithful or contact-analog manner at a customary mirror position of a vehicle mirror, such as e.g. in an upper region of the windshield.

The image representation of the rear vehicle environment is captured by an environment capture device comprising one or more cameras arranged on the vehicle. From the camera images from one or more cameras, the continuous camera image representation of the rear vehicle environment can then be rendered by way of suitable image processing methods, such that a kind of panoramic image of the rear vehicle environment is formed. Moreover, the camera image representation of the rear vehicle environment can be perspectively corrected.

Furthermore, the 3D capture device of the environment capture device can have a lidar, radar or ultrasonic sensor system in order to capture a distance profile with respect to the rear vehicle environment, in particular with respect to the environment objects. The distance profile indicates a direction-dependent distance to environment structures or environment objects for the spatial directions.

It can be provided that ascertaining the spatial image representation of the rear vehicle environment is carried out by methods of sensor fusion of the camera image representation and the distance profile. By way of the sensor data fusion, a spatial image representation (RGBD image) can thus be generated from the camera image representation of the rear vehicle environment and the distance profile. Machine learning algorithms trained to recognize correspondences can be used for such sensor data fusion in a manner known per se. In this way, for example, images from different sequences are compared, associated objects are recognized and the depth is obtained by way of the distance profile. The depth information is usually calculated and subsequently used in the form of voxels.

The above method comprises providing the spatial image representation of a rear vehicle environment in a positionally faithful or contact-analog manner with respect to a vehicle coordinate system for the purpose of display at a vehicle mirror position, e.g. in an upper region of a windshield of the motor vehicle.

The presentation in the smartglasses can be effected with the aid of a game engine/3D graphics engine which is implemented in the smartglasses and which converts the communicated spatial image representation into display images for the display surfaces of the smartglasses. The spatial image representation ascertained by the vehicle is transmitted to the smartglasses. There it is presented in the form of a virtual 3D world by generation of stereoscopic display images (e.g. by way of point clouds, RGBD images or voxels) and is rendered from the user's perspective.

A 3D graphics engine is a specialized software component or a system which facilitates the creation and presentation of three-dimensional graphics in real time. A 3D graphics engine comprises a rendering algorithm which makes it possible to generate a 3D image from a 2D scene (RGBD image), that is to say that the spatial image representation is created with the aid of suitable rendering methods. From the 3D image, it is possible for virtual cameras to create perspectively stereoscopic display images for the smartglasses. Smartglasses are generally binocular (display surface for each eye), that is to say that the perspectively correct image is rendered for each eye. The stereoscopic vision thus produces a 3D impression.

It can be provided that a glasses pose is provided in a vehicle-fixed assistance system, wherein a portion of the spatial image representation of the rear vehicle environment is ascertained as object information which is perceptible in the smartglasses according to the glasses pose in the case of the driver's viewing direction, wherein the portion of the spatial image representation of the rear vehicle environment is communicated to the smartglasses in order to display the latter there in a contact-analog manner.

In order to reduce the data rate when transmitting the image representation of the rear vehicle environment to the smartglasses, only a part of the image representation of the rear vehicle environment is thus transmitted to the smartglasses pose-dependently on a glasses pose of the smartglasses, which part includes a portion corresponding to the currently perceptible portion of the image representation of the rear vehicle environment. The bandwidth of the data transmission to the smartglasses which is required for the current presentation of the portion of the image representation of the rear vehicle environment can be considerably reduced in this way.

According to a further aspect, a display system for operating smartglasses in a motor vehicle is provided, comprising:
an environment capture device comprising a camera system designed to capture or to determine a camera image representation of a rear vehicle environment, and comprising
a 3D capture device designed to capture a distance profile of the rear vehicle environment; a control unit designed to determine a spatial image representation on the basis of the camera image representation and the distance profile; and
a communication device designed to communicate at least one portion of the spatial image representation of the rear vehicle environment as object information to the smartglasses.

Furthermore, the display system can comprise smartglasses, wherein the smartglasses are designed to generate display images for stereoscopic presentation on display surfaces of the smartglasses on the basis of the spatial image representation, and to present the display images in contact-analog fashion on the display surfaces of the smartglasses in a presentation region at a vehicle-fixed position, which region corresponds to a vehicle mirror position, wherein the display images are created depending on the spatial image representation of the rear vehicle environment with the aid of a graphics engine/game engine implemented in the smartglasses in order to enable a spatial or stereoscopic presentation of environment objects of the rear vehicle environment.

The presentation region of the windshield may be tinted or blackened.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of a display system in a vehicle for presenting a virtual image representation of the rear vehicle environment.

FIG. 2 shows a schematic illustration of the display system.

FIG. 3 shows a flowchart for elucidating the method for operating the display system.

### DETAILED DESCRIPTION OF THE DRAWINGS

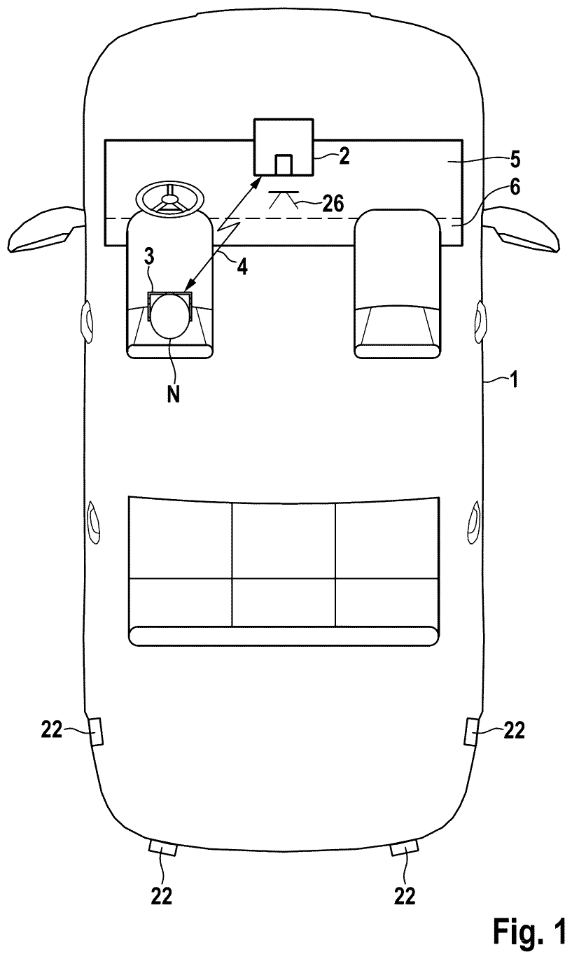

FIG. 1 schematically shows a plan view of a display system with a vehicle 1, in which a driver or a vehicle occupant N is wearing smartglasses 3. The smartglasses 3 are connected to a vehicle-fixed assistance system 2 via a communication connection 4. The communication connection 4 is designed as a data transmission channel, for example in the form of a wireless or a wired communication connection. The communication connection 4 is able to communicate any kind of data and information between the assistance system 2 and the smartglasses 3, for example on the basis of a packet-mode data transmission. For example, the communication connection 4 may be based on Wi-Fi, Bluetooth, Bluetooth Low Energy, or a comparable standardized radio protocol.

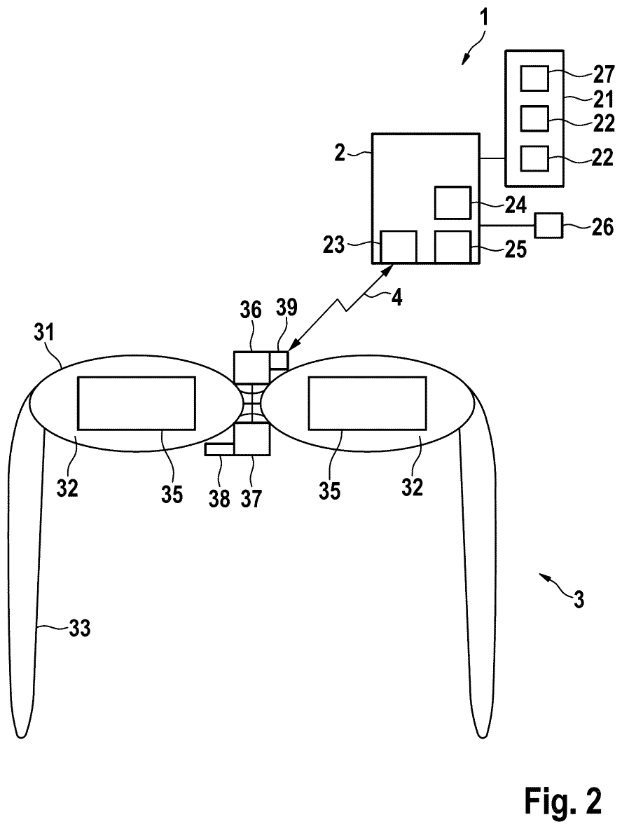

FIG. 2 shows a schematic illustration of the display system.

The assistance system 2 may be provided in particular in a positionally fixed fashion in the vehicle 1. The assistance system 2 may be equipped with a communication unit 23 enabling the data to be transmitted between the smartglasses 3 and the assistance system 2 via the communication connection 4.

The assistance system 2 may furthermore be connected to an environment capture system 21 having a plurality of cameras 22 directed into the external vehicle environment. The cameras 22 may capture in particular the rear vehicle environment in the form of camera images. The one or more cameras 22 may comprise for example an RGB camera, an IR camera, a fisheye camera, a dynamic vision sensor and the like.

The environment capture system may furthermore be provided with a 3D capture device 27 in order to capture a distance profile of the rear vehicle environment.

The assistance system 2 may have a control unit 24 in order to combine and/or to render the simultaneously captured camera images to form a single camera image representation and to provide this in real time. The control unit 24 may furthermore be designed to fuse the camera image representation with the distance profile with the aid of a sensor data fusion method and thus to obtain a spatial image representation which can be provided e.g. in the form of an RGBD image or voxels.

Furthermore, the assistance system 2 comprises a vehicle motion sensor system (IMU sensor system) 25, which may be designed for example in the form of a 6-DoF inertial sensor. This provides movement indications in relation to a movement of the vehicle 1 in the form of translational accelerations or angular accelerations or angular speeds.

The smartglasses 3 comprise two transparent lenses 32 that are enclosed in a frame 31 in a manner known per se. The frame 31 is provided, by way of example, with glasses temples 33, so that the smartglasses 3 are able to be worn on the head of a user.

One or both lenses 32 (glasses lenses) are furthermore provided with a transparent display surface 35, through which a display image for presenting virtual display objects is able to be projected in the eye of the wearer of the smartglasses 3 by a suitable device, such as for example a display device 36 arranged on the frame 31. The display device 36 may have a microprocessor or a comparable computing unit and a display unit, such as for example a projection device or the like. The display unit may be designed to direct the electronically generated display image onto the display surface 35 and to image/present it there.

Owing to the transparent design of the display surface 35, the electronically generated image is able to overlay the real environment perceptible through the display surface 35. The display device 36 may be used to present a virtual display object, such as for example a text, a symbol, video information, a graphic or the like, on one or both display surfaces 35.

The smartglasses 3 may be worn on the head of the user like a typical visual aid, wherein the smartglasses 3 may rest on the nose of the user by way of the frame 31 and the temples 33 may lie laterally against the head of the user. The viewing direction of the user straight ahead is then effected through the transparent display surfaces 35 of the lenses 32, such that the viewing direction and position of the user, specified by an eye position and an optical visual axis (eye axis), have a fixed reference with respect to the position and orientation of the smartglasses 3, i.e. the glasses pose.

For the display of display objects, such as graphical symbols, text or image data, corresponding object information in the form of object data is communicated from the assistance system 2 to the smartglasses 3 or already provided in the smartglasses 3. In this case, the object data indicate the kind of display object, such as e.g. a text object, an icon or some other identification of a display region, and the object pose (position and orientation) of the display object for a contact-analog presentation. The object pose may be indicated in relation to a world-fixed environment coordinate system or a vehicle-fixed vehicle coordinate system.

Provision may be made of a glasses motion sensor system 38 (IMU sensor system, inertial sensor system) that is designed for example in the form of a 6-DoF inertial sensor. This provides relative or differential glasses movement information in relation to a movement of the smartglasses 3 in the form of translational accelerations and angular accelerations or angular speeds, which may be converted, in particular by a respective (inter alia double) integration, into a change in position and orientation, that is to say a differential glasses pose, such that it is possible to update an indication in relation to an absolute glasses pose at high frequency by applying a time integration method.

The relative or differential glasses movement information in the form of changes in position and orientation ascertained via the glasses motion sensor system 38 can be used, in a manner known per se, to determine a world-fixed glasses pose indication for a current glasses pose of the smartglasses 3. In order to ascertain a vehicle-fixed absolute glasses pose indication, the glasses movement information must be adjusted depending on the vehicle movement information (also relative or differential), such that only the movement of the smartglasses 3 in the vehicle 1 can be evaluated. In this case, the difference in movement between the movement of the smartglasses and the movement of the vehicle 1 is ascertained and evaluated for the purpose of ascertaining the glasses pose.

With the aid of a control unit 37, it is possible to receive e.g. object information via a communication device 39 from the assistance system 2 or provide and process the object information in some other way, such that the represented display objects are displayed in a contact-analog manner depending on the glasses pose with respect to the vehicle coordinate system in the respective viewing angle range in which the user of the smartglasses 3 looks and in which environment objects are able to be perceived. In other words, the display object indicated by the object information is displayed on the display surface 35 if its vehicle-fixed position is in the viewing angle range of the smartglasses 3.

The user N of the smartglasses 3 is located as an occupant in the vehicle 5, and the glasses pose of the smartglasses 3 can change by virtue of head movements and a movement of the vehicle. For the contact-analog presentation of a display object relative to an environment position, i.e. the corresponding object information is provided with an environment position, on the display surface of the smartglasses 3, an absolute glasses pose indication relative to the environment coordinate system must be available in the smartglasses 3. Accordingly, for the contact-analog presentation of a display object relative to a vehicle-fixed position, i.e. the corresponding object information is provided with a position relative to the vehicle, on the display surface of the smartglasses 3, an absolute glasses pose indication relative to the vehicle coordinate system must be available in the smartglasses 3.

For the realization of the vehicle mirror function, a specific item of the object information corresponds to a portion of the image representation of the rear vehicle environment which is currently perceptible depending on the current glasses pose of the driver. For this purpose, the object information is assigned to the position or the region of a presentation region 6 on a windshield 5. The presentation region 6 corresponds to a vehicle-fixed position in an upper section of the windshield 5 and may extend over 50%-100% of the width of the windshield 5. If the driver is not looking at the presentation region 6, then the transmission of the specific object information can be stopped. If the driver is looking at a part of the presentation region, then the transmission of the specific object information may concern only that portion of the image representation of the rear vehicle environment which is assigned to the corresponding assigned part of the presentation region.

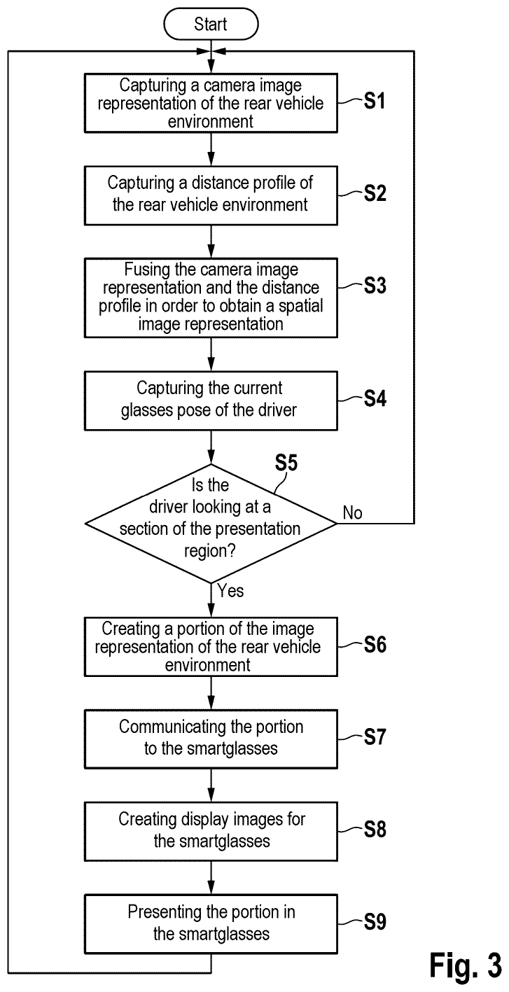

FIG. 3 shows a flowchart for elucidating a method for presenting an image representation of a rear vehicle environment as a virtual vehicle mirror for a driver of a motor vehicle.

Rear vehicle environment is understood to mean, relative to the longitudinal direction of the vehicle, a range between −110°-−70° and 70°-110° in a horizontal plane with backward orientation, i.e. the angle 0° corresponds to the vehicle longitudinal direction toward the rear.

An image representation of the rear vehicle environment then corresponds to the camera image representation resulting from the recording of the rear vehicle environment. The camera image representation of the rear vehicle environment can be used in particular in mirror-inverted fashion and can be used for the purpose of presentation in the smartglasses 3. In this case, the image representation of the rear vehicle environment presents object information which is positioned in the presentation region of the windshield 5 in a positionally fixed manner relative to a vehicle coordinate system. For this purpose, as presentation region 6 in accordance with a conventional vehicle mirror, use is made of an upper region of the windshield 5, for example having a height of between 5% and 20%, e.g. 10%, of the windshield proceeding from the upper edge of the windshield 5.

The presentation region is preferably tinted or blackened in order to obtain good image perception for the presentation of the image information of the image representation of the rear vehicle region.

The method described below is carried out cyclically.

In step S1, firstly with the aid of the camera system 22 of the environment capture system 21, the rear vehicle environment is captured at a current point in time. If the rear vehicle environment is captured by the plurality of cameras 22 or the like, then a composite camera image representation of the rear vehicle environment is created or rendered. In particular, a perspective correction can also take place, in particular relative to the driver's position, which can be derived from the position of the smartglasses 3.

In step S2, a distance profile with respect to environment structures or environment objects of the rear vehicle environment is captured with the aid of the 3D capture system. By way of example, the 3D capture system can comprise a lidar, radar and/or ultrasonic sensor system and determine the respective distance in a specific capture direction.

In step S3, the camera image representation and the distance profile are fused with one another with the aid of a sensor data fusion in the control unit 24 in order to obtain a spatial image representation, e.g. as an RGBD image, of the rear vehicle environment.

In step S4, the glasses pose of the smartglasses 3 of the driver is captured in the assistance system 2. This can be done for example by an interior tracking system having an interior camera 26 directed at the driver. By way of corresponding vision tracking methods, an absolute glasses pose indication in the form of a position and orientation of the smartglasses 3 can be ascertained from the interior camera image thus captured, and the direction in which the driver is looking is thus clear.

Step S5 involves checking, on the basis of the glasses pose indication, whether the driver is looking at a vehicle mirror position, e.g. in the upper section of the windshield 5 (interior mirror) or at a front part of the front side window (exterior mirror). Conventional 3D image processing methods are used for this purpose. If it is established that the driver's viewing direction is directed at a vehicle mirror position (alternative: Yes), then the method is continued with step S6. In the alternative (alternative: No), the method returns to step S1.

Step S6 involves creating a portion from the spatial image representation of the rear vehicle environment. The portion corresponds to a portion of the spatial image representation which is intended to be perceptible via the vehicle mirror position. This portion is intended to simulate the vehicle mirror (mirror-image presentation).

In a subsequent step S7, the corresponding portion of the spatial image representation of the rear vehicle environment is transmitted as object information to the smartglasses 3.

In step S8, with the aid of a 3D graphics engine, the spatial image representation is created in the form of stereoscopic display images for the two display surfaces of the smartglasses 3, which enable a spatial perception of the rear vehicle environment.

In the smartglasses 3, in step S9, the display images are then displayed in a contact-analog manner on the display surfaces 35 of the smartglasses 3, such that the latter, in the field of view thereof, sees the corresponding portion of the spatial image representation of the rear vehicle environment. If the driver is not looking at the vehicle mirror region, then the transmission of the corresponding portion of the spatial image representation of the rear vehicle environment can completely cease in order thus to conserve the bandwidth of the data transmission channel between the assistance system 2 and the smartglasses 3.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Vehicle
2 Assistance system
3 Smartglasses
4 Communication connection
5 Windshield
6 Presentation region
21 Environment capture device
22 Cameras
23 Communication unit
24 Control unit
25 Vehicle motion sensor system
26 Interior camera
27 3D capture device
31 Frame
32 Lenses
33 Glasses temples
35 Display surface
36 Display device
37 Control unit
38 Glasses motion sensor system
39 Communication device
N Vehicle occupant

What is claimed is:

1. A method for operating a display system for smartglasses in a motor vehicle, the method comprising:
ascertaining a spatial image representation of a rear vehicle environment with the aid of an environment capture device comprising a camera system for providing a camera image representation and a 3D capture device for providing a distance profile;
communicating at least one portion of the spatial image representation of the rear vehicle environment as object information to the smartglasses; and
performing contact-analog presentation of display images on a display surface of the smartglasses in a presentation region at a vehicle-fixed position, which presentation region corresponds to a vehicle mirror position, wherein the display images are created stereoscopically depending on the spatial image representation of the rear vehicle environment with aid of a graphics engine implemented in the smartglasses in order to enable a spatial presentation of environment objects of the rear vehicle environment.

2. The method according to claim 1, wherein ascertaining the spatial image representation of the rear vehicle environment is carried out by methods of sensor data fusion of the camera image representation and the distance profile.

3. The method according to claim 1, wherein the image representation of the rear vehicle environment is presented in mirror-inverted fashion.

4. The method according to claim 1, wherein:
a glasses pose is provided in a vehicle-fixed assistance system,
a portion of the spatial image representation of the rear vehicle environment is ascertained as object information which is perceptible in the smartglasses according to the glasses pose in a case of a driver's viewing direction, and
the portion of the spatial image representation of the rear vehicle environment is communicated to the smartglasses in order to display the portion of the spatial image representation of the rear vehicle environment there in a contact-analog manner.

5. The method according to claim 1, wherein the display images for display on the display surfaces of the smartglasses are created from the spatial image representation with aid of a 3D graphics engine.

6. A display system for operating smartglasses in a motor vehicle, the display system comprising:
an environment capture device comprising a camera system configured to capture or to determine a camera image representation of a rear vehicle environment, and comprising a 3D capture device configured to capture a distance profile of the rear vehicle environment,
a control unit configured to determine a spatial image representation based on the camera image representation and the distance profile; and
a communication unit configured to communicate at least one portion of the spatial image representation of the rear vehicle environment as object information to the smartglasses.

7. The display system according to claim 6, further comprising the smartglasses, wherein:
the smartglasses are configured to generate display images for stereoscopic presentation on display surfaces of the smartglasses based on the spatial image representation, and to present the display images in contact-analog fashion on the display surfaces of the smartglasses in a presentation region at a vehicle-fixed position, which presentation region corresponds to a vehicle mirror position, and
the display images are created depending on the spatial image representation of the rear vehicle environment with aid of a graphics engine or a game engine implemented in the smartglasses in order to enable a spatial or stereoscopic presentation of environment objects of the rear vehicle environment.
